(19) United States
(12) Patent Application Publication
(10) Pub. No.: US 2022/0138136 A1
(43) Pub. Date: May 5, 2022

(54) DIE TO DIE PHYSICAL LAYER TRANSLATION SWITCH

(71) Applicant: Mercury Systems, Inc., Andover, MA (US)

(72) Inventor: Charles Edwin Hudnall, JR., Huntsville, AL (US)

(21) Appl. No.: 17/512,108

(22) Filed: Oct. 27, 2021

Related U.S. Application Data
(60) Provisional application No. 63/109,934, filed on Nov. 5, 2020.

(51) Int. Cl. G06F 13/40; G06F 13/42

(52) U.S. Cl. CPC G06F 13/4022; G06F 13/4282; G06F 13/4204

(57) ABSTRACT

A physical translation switch may have two parallel channel interfaces (e.g., BoW interfaces) and two serial channel interfaces (e.g., XSR interfaces). The translation switch may have a parallel switching fabric for directing input traffic from input ports on a first type of channel interface to output ports of a second type of channel interface. Thus, when one wants to connect a chiplet with a BoW interface to a chiplet with an XSR interface, the translation switch is connected between the chiplets to provide the needed compatibility. The translation switch provides the needed compatible channel interfaces for the chiplets.

### RELATED APPLICATIONS

This application claims the benefit of U.S. Provisional Patent Application No. 63/109,934 filed Nov. 5, 2020, the contents of which are incorporated herein in their entirety.

### BACKGROUND

In a traditional integrated circuit (IC), a single die was packaged separately and positioned on a printed circuit board (PCB). As things have evolved, an IC now may contain multiple dies in a single package. More recently, a System on a Chip (SoC) has been introduced. With an SoC, multiple components of a computer or an electronic system are integrated into a single IC package. For example, an SoC package may contain a Central Processing Unit (CPU), Input/Output (I/O) ports, memory and secondary storage.

There is an increasing interest in using chiplets with SoC's. A chiplet is a functional modular block (formed of a single die) that has been specifically designed to work with other similar chiplets to form larger more complex chips. With such chiplets, there is a need to interconnect the chiplets with other chiplets, such as in SoC's. Manufacturers have attempted to create proprietary ecosystems for use of such chiplets. Two primary standards have emerged for interconnecting chiplets. A first category of standards in the Bunch of Wires (BoW) parallel interface, and a second category are high-speed SERializer/DESerializer (SERDES) interfaces such as the eXtra Short Reach (XSR) standard.

FIG. 1 shows an example of a SoC 100 for a Field Programmable Gate Array (FPGA) chiplet 102 that is connected with four chiplets 104A, 104B, 104C and 104D. The chiplets 104A, 104B, 104C and 104D are wideband I/O chiplets that provide I/O capabilities. The chiplets are connected to the FPGA chiplet 102 via BoW interfaces 108 and 112 on the FPGA chiplet 102 and the chiplets 104A, 104B, 104C and 104D.

### SUMMARY

In accordance with a first inventive aspect, an apparatus for physically interfacing a first die with a second die includes a first parallel channel interface for interfacing with parallel channels on one of the first die or the second die. The apparatus also includes a first serial channel interface for interfacing with serial channels on one of the first die or the second dies. The apparatus further includes a cross-connect switching fabric for directing inputs received from the first die via one of the channel interfaces as outputs to the second die via another of the channel interfaces.

The apparatus may include bit reordering electrical circuitry for reordering received bits for the first parallel channel interface. The bit reordering circuitry may produce a reversed sequence of bits relative to a received sequence of the received bits. The apparatus may additionally include redundancy electrical circuitry for providing bit redundancy for received bits of the parallel channel interface. The apparatus may include a medium access control (MAC) controller for providing multiplexing and flow control in the first parallel channel interface. The first parallel channel interface may be a Bunch of Wires (BoW) interface. The first serial channel interface may be an SERDESD interface. The apparatus may further include a second serial channel interface. The apparatus may have four sides that form an outer boundary that is rectangular, and the first serial channel interface may be positioned on a first of the sides of the boundary of the apparatus and the second serial interface may be positioned on opposite one of the sides of the boundary of the apparatus. The apparatus may include a second parallel channel interface.

The apparatus may have four sides that form an outer boundary that is rectangular. The first parallel channel interface may be positioned on a first of the sides of the boundary of the apparatus, and the second parallel interface may be positioned on opposite one of the sides of the boundary of the apparatus. The switching fabric may be a parallel switching fabric.

In accordance with another inventive aspect, a system on a chip (SoC) includes a first die and a second die. The SoC further includes an apparatus for interfacing the first die with the second die. The apparatus has a first parallel channel interface for interfacing with parallel channels on one of the first die or the second die and a first serial channel interface for interfacing with serial channels on one of the first die or the second die. The apparatus also includes a cross-connect switching fabric for directing inputs received from the first die via one of the channel interfaces as outputs to the second die via another of the channel interfaces. The first die may be a chiplet. The second die may be a chiplet, and the apparatus may be a chiplet.

In accordance with an additional inventive aspect, an apparatus for physically interfacing a first die with a second die includes a first parallel channel interface configured for interfacing with parallel channels on a die with parallel channels. The apparatus also includes a second parallel channel interface configured for interfacing with parallel channels on another die with parallel channels. The apparatus further includes a first serial channel interface configured for interfacing with serial channels on a die with serial channels and a second serial channel interface configured for interfacing with serial channels on another die with serial channels. Still further, the apparatus includes a cross-connect switching fabric for directing inputs received from the first die via one of the channel interfaces as outputs to the second die via another of the channel interfaces. The parallel channel interfaces may be Bunch of Wires (BoW) interfaces. The serial channel interfaces may be SERDES interfaces.

### BRIEF DESCRIPTION OF THE DRAWINGS

FIG. 1 depicts a conventional SoC where BoW interfaces interconnect chiplets.

FIG. 2 depicts a SoC where XSR interfaces interconnect chiplets.

FIG. 3 depicts a translation switch of an exemplary embodiment.

FIG. 4 depicts a more detailed view of the translation switch of FIG. 3.

FIG. 5 depicts an exemplary embodiment where BoW interfaces of the translation switch interconnect chiplets in an exemplary embodiment.

FIG. 6 depicts an exemplary embodiment where a BoW interface and an XSR interface interconnect chiplets in an exemplary embodiment.

### DETAILED DESCRIPTION

One of the problems with parallel interfaces, like BoW, and SERDES interfaces, like XSR interfaces, is that they only work within their respective proprietary ecosystems. As such, chiplets with BoW interfaces can only interface with other chiplets that have BoW interfaces. Similarly, chiplets with XSR interfaces can only interface with other chiplets that have XSR interfaces. This may be problematic when one wishes to interconnect a chiplet with a BoW interface with a chiplet that has an XSR interface. More generally, this may be problematic is trying to interconnect proprietary parallel interfaces with proprietary SERDES interfaces.

The exemplary embodiments solve this problem by providing a die to die physical layer translation switch. The translation switch may have two parallel channel interfaces (e.g., BoW interfaces) and two serial channel interfaces (e.g., XSR interfaces). The translation switch may have a parallel switching fabric for directing input traffic from input ports on a first type of channel interface to output ports of a second type of channel interface. Thus, when one wants to connect a chiplet with a BoW interface to a chiplet with an XSR interface, the translation switch is connected between the chiplets to provide the needed compatibility. The translation switch provides the needed compatible channel interfaces for the chiplets.

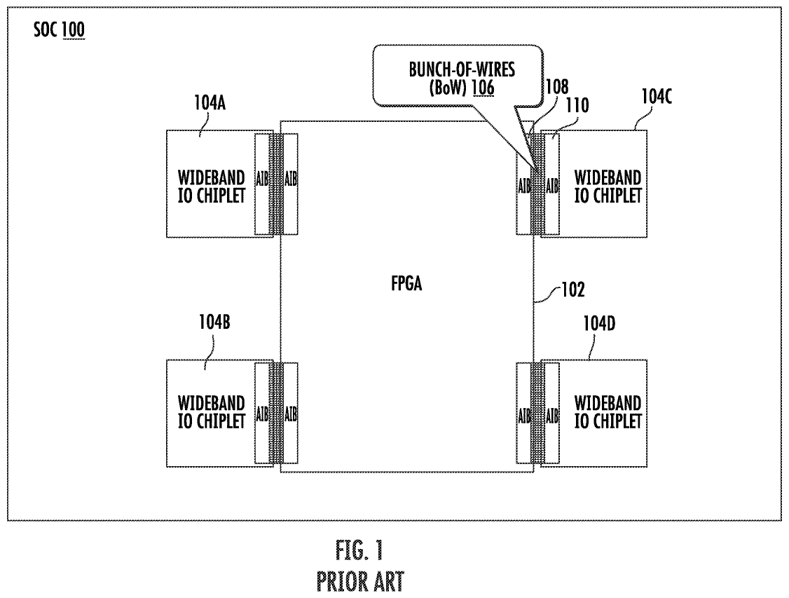

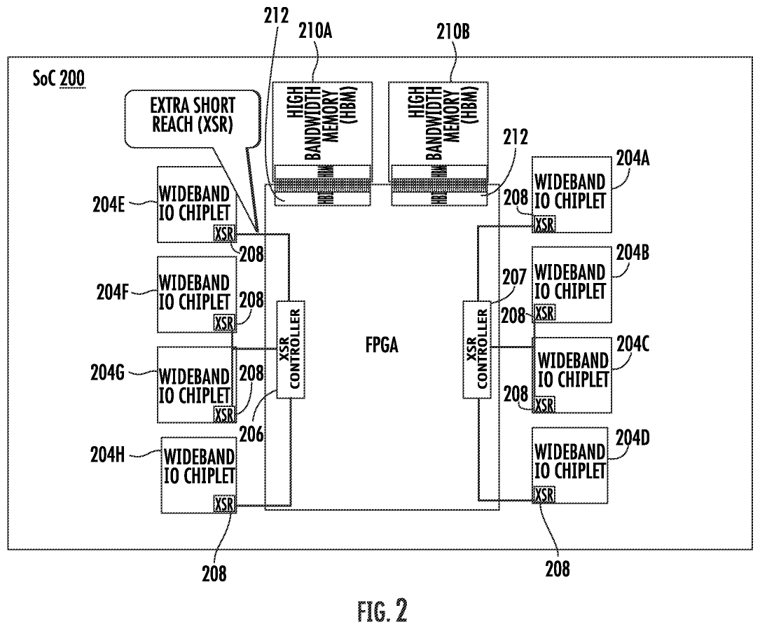

FIG. 1 depicted a parallel interface in the form of a BoW interface. In order to better appreciate the exemplary embodiments, it is also helpful to consider the SERDES interfaces, like XSR interfaces as well. FIG. 2 shows an example of a SoC 200 for an FPGA chiplet 202 with wideband I/O chiplets 204A, 204B, 204C, 204D, 204E, 204F, 204G and 204H. The chiplets 204A-204H are connected to the FPGA chiplet 202 via XSR interfaces 208. An XSR controller 206 is provided on the FPGA die 202 for controlling the XSR interfaces 208 of wideband I/O chiplets 204E-204H, and another XSR controller 207 is provided for controlling the XSR interfaces 208 of wideband I/O chiplets 204A-204D. High bandwidth memory chiplets 210A and 210B are connected to the FPGA chiplet 202. The FPGA chiplet 202 has High-Bandwidth Interconnect (HBI) interfaces 212 for interfacing with the high bandwidth memory chiplets 210A and 210B.

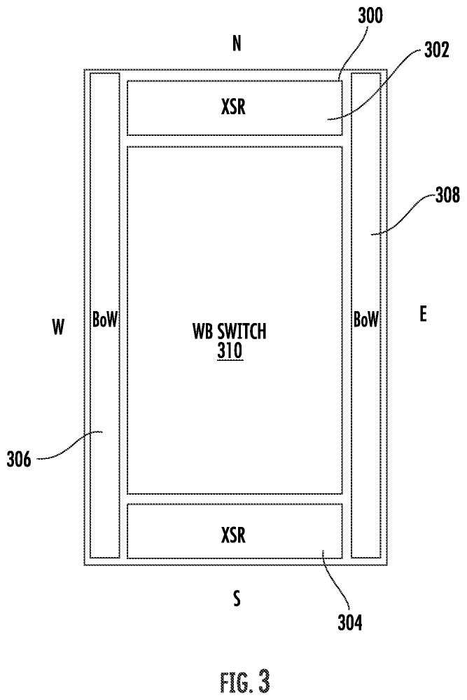

As was discussed above, the exemplary embodiments can work with both SERDES interfaces and parallel interface. FIG. 3 depicts an example translation switch 300 in accordance with an exemplary embodiment. The translation switch is formed as an interface apparatus that is a chiplet. As was mentioned above, the translation switch interconnects chiplets with different channel interfaces. To allow such interconnections, the translation switch 300 has four channel interfaces that occupy beach heads on each of the respective sides of the translation switch 300. In the example shown in FIG. 3, XSR channel interfaces 302 and 304 are positioned on the north (“N’) side and the south (“S”) side of the translation switch 300. Thus, the XSR channel interfaces 302 and 304 are positioned on opposite sides of the translation switch 300. The outer boundary of the translation switch has a rectangular shape and the XSR channel interfaces 302 and 304 are parallel to each other on opposite sides. The positioning on the opposite sides helps to accommodate XSR channel interface connections with chiplets that have their XSR channel interfaces on various sides of the chiplets. BoW channel interfaces 306 and 308 may also be provided. The BoW channel interfaces may be provided on opposite sides of the translation switch. In FIG. 3, the BoW interfaces are positioned on the west (“W”) and east (“E”) sides of the translation switch. The west and east sides are on parallel but opposite sides of the translation switch.

The XSR channel interfaces 302 and 304 are designed to interconnect with chiplets having XSR interfaces. Each XSR channel interface 302 or 304 may act as an I/O interface for the interconnected chiplet. Thus, the translation switch 300 may receive input signals from a chiplet with an XSR interface and provide output signals to a chiplet with an XSR interface. Similarly, each BoW interface 306 or 308 may act as an I/O interface for an interconnected chiplet with a corresponding BoW interface. Thus, the translation switch 300 may receive input signals from a chiplet with a BoW interface and provide output signals to a chiplet with a BoW interface.

A cross-connect switching fabric 310 is provided in the translation switch. The cross-connect switching fabric 310 is a parallel switching fabric. The role of the cross-connect switching fabric 310 is to connect input ports with output ports. The XSR channel interfaces 300 and 304 may be connected to the cross-connect switching fabric 310. The BoW channel interfaces 306 and 308 may also be connected to switching fabric 310. In this way, the switching fabric 310 may direct input signals from any of the channel interfaces 302, 304, 306 and 308 to output ports in any other of the otherwise incompatible channel interfaces 302, 304, 306 and 308. The cross-connect switching fabric 310 is configured once before first use of the translation switch and not changed again. The configuration may create a switching table that maps input ports on a first of the channel interfaces 302, 304, 306 or 308 to output ports of another of the channel interfaces 302, 304, 306 or 308 that is of a different channel interface type. Thus, input ports of an XSR channel interface 302, 304 may be configured to be connected via the cross-connect switching fabric 310 with output ports of a BoW channel interface 306, 308. Likewise, Thus, input ports of a BoW channel interface 306, 308 may be configured to be connected via the cross-connect switching fabric 310 with output ports of a BoW channel interface 302, 304.

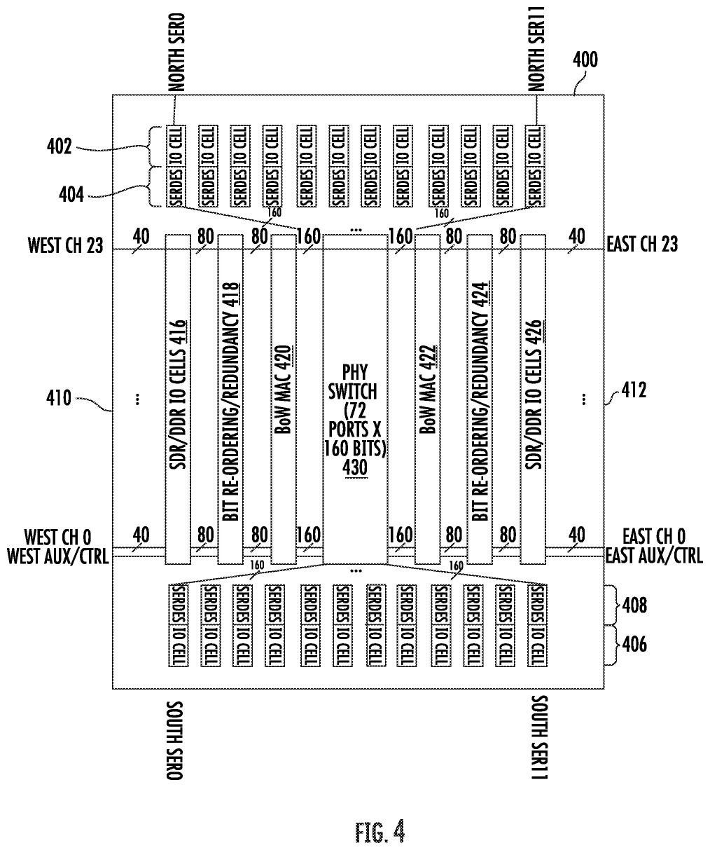

FIG. 4 depicts a more detailed view of a translation switch 400 of an exemplary embodiment. As can be seen in FIG. 4, the XSR interfaces at the north and south sides of the translation switch 400 include 12 high speed serial channel input/output cells 402, designated as NorthSer0 to NorthSer11 on the north side and 12 high speed serial channel input/output cells 406 designated as SouthSer0 to SouthSer11 on the south side. Each of the channels may be a 112 Gbps channel. A set of serializers/deserializers 404 and 408 are provided in the respective XSR interfaces on the north and south sides. A serializer/deserializer 404, 408 is provided for each channel to deserialize the serial input to create parallel input and to serialize parallel output into serial output. The XSR interfaces are connected to the cross-connect switching fabric 430 and provide 160 bits of input/output from/to the channels. The cross-connect switching fabric 430 is a parallel switching fabric with 72 ports.

FIG. 4 also depicts the BoW channel interfaces 410 and 412 positioned on the west and east sides of the translation switch 400. Each of the BoW channel interfaces 410 and 412 includes Single Data Rate (SDR)/Double Data Rate (DDR) I/O cells 416, 426. The I/O cells 416 and 426 include SDR input cells, SDR output cells, DDR input cells and DDR output cells. There are 40 24-bit wide channels. The solder bumps provided by the BoW interfaces 410 and 412 are configured to match the pattern provided defined in the BoW standard. However, because the Bow interfaces 410 and 412 may be connected to different sides of the chiplet having a BoW interface, bit reordering/redundancy logic 418 is provided. The reordering logic in the bit reordering/redundancy logic 418 can invert the order of the bits to accommodate the defined sequence of the chiplet to which the translation switch is to be connected. Thus, for example, suppose the bumps on the chiplet provide the bits of the channels in a sequence from 19 to 0, the reordering logic may sequence the bits in these channels to the sequence from 0 to 19. The redundancy part of the bit reordering/redundancy logic provides bit redundancy. The bit redundancy accommodates repair of a bus after the translation switch is connected to the chiplets. The repair is performed by firmware that is resident within the BoW MAC and SDR/DDR IO Cells that will test each bit for proper connectivity and shift the redundant bits into the path in the event of opens between the chiplet bit paths.

The Bow interfaces 410 and 412 include Medium Access Control (MAC) controllers 420 and 422 for protocol decoding between BoW MAC to AIB or OpenHBI. This ensures that the input data is in proper form as output data. The BoW MAC implements either the AIB or OpenHBI protocols and converts each of those protocols to a general parallel data path that can be switched between each of the remaining sides of the device.

It should be appreciated that some embodiments may only include a single XSR channel interface and/or a single BoW channel interface.

It will also be appreciated that the parallel channel interface need not be a BoW channel interface, and the serial channel interface need not be an XSR channel interface. Other varieties of parallel interfaces may be used in exemplary embodiments. Moreover, other varieties of SERDES interfaces may be used in exemplary embodiments. The specification of BoW and XSR is intended to be illustrative and not limiting.

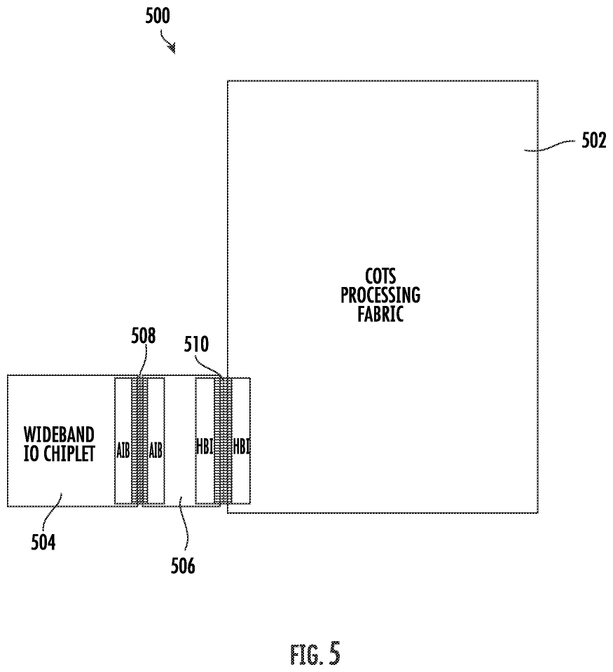

FIG. 5 depicts an example where a SoC 500 includes a processing fabric chiplet 502 that is connected to the translation switch 506 via a BoW interface 510 of the east side of the translation switch 506. The west side of the translation switch is interconnected via a BoW interface 508 with a wideband I/O chiplet 504.

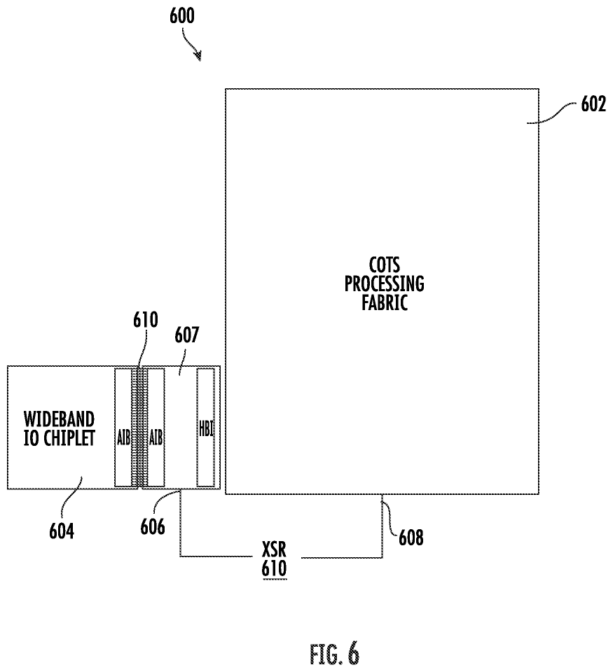

FIG. 6 depicts example like FIG. 5 where the wideband I/O chiplet 604 is interconnected to the translation switch 607 via BoW interface but is connected to the processing fabric chiplet 502 via an XSR connection between the south side XSR interface 606 of the translation switch and a corresponding XSR interface 608 on the south side of the processing fabric chiplet 602.

While exemplary embodiments have been described herein, it will be appreciated that various changes in form and detail may be made without departing from the intended scope as defined in the appended claims.

1. An apparatus for physically interfacing a first die with a second die, comprising:
a first parallel channel interface for interfacing with parallel channels on one of the first die or the second die;
a first serial channel interface for interfacing with serial channels on one of the first die or the second die; and
a cross-connect switching fabric for directing inputs received from the first die via one of the channel interfaces as outputs to the second die via another of the channel interfaces.

2. The apparatus of claim 1, further comprising bit reordering electrical circuitry for reordering received bits for the first parallel channel interface.

3. The apparatus of claim 2, wherein the bit reordering circuitry produces a reversed sequence of bits relative to a received sequence of the received bits.

4. The apparatus of claim 1, further comprising redundancy electrical circuitry for providing bit redundancy for received bits of the parallel channel interface.

5. The apparatus of claim 1, further comprising a medium access control (MAC) controller for providing multiplexing and flow control in the first parallel channel interface.

6. The apparatus of claim 1, wherein the first parallel channel interface is a Bunch of Wires (BoW) interface.

7. The apparatus of claim 1, wherein the first serial channel interface is a SERializer/DESerializer (SERDES) interface.

8. The apparatus of claim 1, further comprising a second serial channel interface.

9. The apparatus of claim 8, wherein the apparatus has four sides that form an outer boundary that is rectangular and wherein the first serial channel interface is positioned on a first of the sides of the boundary of the apparatus and the second serial interface is positioned on opposite one of the sides of the boundary of the apparatus.

10. The apparatus of claim 1, further comprising a second parallel channel interface.

11. The apparatus of claim 10, wherein the apparatus has four sides that form an outer boundary that is rectangular and wherein the first parallel channel interface is positioned on a first of the sides of the boundary of the apparatus and the second parallel interface is positioned on opposite one of the sides of the boundary of the apparatus.

12. The apparatus of claim 1, wherein the switching fabric is a parallel switching fabric.

13. A system on a chip, comprising:
a first die;
a second die;
an apparatus for interfacing the first die with the second die, comprising:
a first parallel channel interface for interfacing with parallel channels on one of the first die or the second die;
a first serial channel interface for interfacing with serial channels on one of the first die or the second dies; and
a cross-connect switching fabric for directing inputs received from the first die via one of the channel interfaces as outputs to the second die via another of the channel interfaces.

14. The system on a chip of claim 13, wherein the first die is a chiplet.

15. The system on a chip of claim 14, wherein the apparatus is a chiplet.

16. The system on a chip of claim 13, wherein the second die is a chiplet.

17. The system on a chip of claim 16, wherein the apparatus is a chiplet.

18. An apparatus for physically interfacing a first die with a second die, comprising:
a first parallel channel interface configured for interfacing with parallel channels on a die with parallel channels;
a second parallel channel interface configured for interfacing with parallel channels on another die with parallel channels;
a first serial channel interface configured for interfacing with serial channels on a die with serial channels;
a second serial channel interface configured for interfacing with serial channels on another die with serial channels;
a cross-connect switching fabric for directing inputs received from the first die via one of the channel interfaces as outputs to the second die via another of the channel interfaces.

19. The apparatus of claim 18, wherein the parallel channel interfaces are Bunch of Wires (BoW) interfaces.

20. The apparatus of claim 18, wherein the serial channel interfaces are SERializer/DESerializer (SERDES) interfaces.
